(19) United States
(12) Patent Application Publication
(10) Pub. No.: US 2016/0053920 A1
(43) Pub. Date: Feb. 25, 2016

(54) Conduit Support Assemblies and Methods

(71) Applicant: NEP IP, LLC, Sheridan, WY (US)

(72) Inventors: Joshua Walton, Sheridan, WY (US); Jeff Wiltse, Sheridan, WY (US)

(21) Appl. No.: 14/463,563

(22) Filed: Aug. 19, 2014

(51) Int. Cl. F16L 3/22; F16L 3/10; F16M 13/02

(52) U.S. Cl. CPC F16L 3/221; F16M 13/027; F16L 3/10

(57) ABSTRACT

Conduit support assemblies of the present disclosure can include: a rim configured to encompass a plurality of conduit; a plurality of brackets above the rim and extending toward the center of the rim, each of the brackets having a curved opening configured to receive one of the plurality of conduit; and a center cap configured to couple with the plurality of brackets. Conduit support assemblies may also include: a hub defining a plurality of recesses between extensions emanating from a center of the hub, each of the recesses defining an arcuate portion proximate the center of the hub and opposing linear portions extending toward an outward perimeter of the hub; and a plurality of brackets above the hub and extending toward the center of the hub, each of the brackets having a curved opening wherein when coupled to the hub form a complete circular opening configured to embrace conduit. These assemblies can be used to form other assemblies.

### TECHNICAL FIELD

The present disclosure relates to supporting conduit. Particular embodiments relate to conduit support assemblies and methods that may be utilized in subterranean rooms and/or shafts.

### BACKGROUND

Many industry processes utilize conduits to transfer fluids to facilitate the needs of the industry being applied. These conduits can extend overhead through walkways, along corridors, and through tunnels. These conduits may also extend vertically down through shafts as well. Typically, multiple conduits are provided, and these multiple conduits require support as they are extended along lengths to accomplish the needs of the process. During utilization, the conduits can become fouled, in essence being clogged or they may break down through corrosion.

It may be required to replace and/or separate one of the conduits from the remaining conduits. This task has proved difficult, however, because typically these conduits are supported along their length by the same apparatus or assembly, and that apparatus or assembly does not facilitate the separation of one conduit from many conduits that are being supported by the assembly. The present disclosure provides assemblies that can be utilized to support conduits, and at the same time allow for the separation of a single conduit without sacrificing the support of remaining conduits associated with the single conduit.

### SUMMARY OF THE DISCLOSURE

Conduit support assemblies are provided. The support assemblies can include: a rim configured to encompass a plurality of conduit; a plurality of brackets above the rim and extending toward the center of the rim, each of the brackets having a curved opening configured to receive one of the plurality of conduit; and a center cap configured to couple with the plurality of brackets.

Support assemblies may include: a hub defining a plurality of recesses between extensions emanating from a center of the hub, each of the recesses defining an arcuate portion proximate the center of the hub and opposing linear portions extending toward an outward perimeter of the hub; and a plurality of brackets above the hub and extending toward the center of the hub, each of the brackets having a curved opening wherein when coupled to the hub form a complete circular opening configured to embrace conduit.

Conduit and support assemblies are also provided. These assemblies can include: a first subassembly comprising: a rim configured to encompass a plurality of conduit; a plurality of brackets above the rim and extending toward the center of the rim, each of the brackets having a curved opening configured to receive one of the plurality of conduit; and a center cap configured to couple with the plurality of brackets; a second subassembly comprising: a hub defining a plurality of recesses between extensions emanating from a center of the hub, each of the openings defining an arcuate portion proximate the center of the hub and opposing linear portions extending toward an outward perimeter of the hub; and a plurality of brackets above the hub and extending toward the center of the hub, each of the brackets having a curved opening wherein when coupled to the hub form a complete circular opening configured to embrace conduit; and a plurality of conduit extending between the first and second subassemblies.

Methods for removing conduit from a support assembly are also provided. The methods can include: supporting a plurality of conduit about a central hub component with each of the plurality of conduit being coupled within the central hub component using a bracket; and removing the bracket to release one conduit from the central hub.

### DRAWINGS

Embodiments of the disclosure are described below with reference to the following accompanying drawings.

FIG. 1 is a depiction of a subterranean shaft utilizing conduits and assemblies of the present disclosure.

FIG. 2 is a depiction of a subassembly according to an embodiment of the present disclosure.

FIG. 3 depicts components of the subassembly according to embodiments of the present disclosure.

FIG. 4 is an assembled subassembly according to an embodiment of the present disclosure.

FIG. 5 is a depiction of another subassembly according to an embodiment of the disclosure.

FIG. 6 is a depiction of a completed subassembly as well as components of the subassembly according to embodiments of the present disclosure.

### DESCRIPTION

This disclosure is submitted in furtherance of the constitutional purposes of the U.S. Patent Laws “to promote the progress of science and useful arts” (Article 1, Section 8).

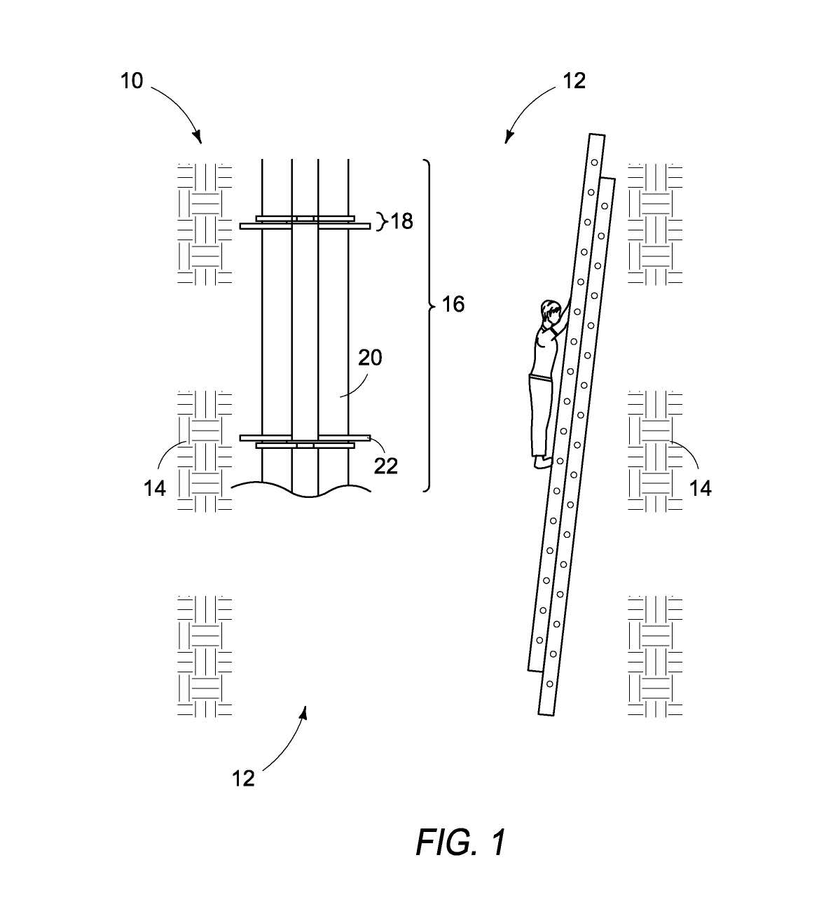

The present disclosure will be described with reference to FIGS. 1-6. Referring first to FIG. 1, a subterranean opening 10 is shown that includes earthen structure 14 defining a shaft 12 therein. Shaft 12 can include an assembly of conduits and subassemblies 16 with a top subassembly 18 being above a lower or intermediate subassembly 22. These subassemblies 18 and 22 can support piping conduit 20, for example. This piping conduit 20 can be less than 12″ in diameter, and as shown can reside along a wall of shaft 12. According to alternative embodiments not shown, assembly 16 can also reside along a roof or wall of a horizontal shaft as well, or a substantially horizontal shaft. It is not necessary that assembly 16 reside vertically within a vertical shaft as shown. As shown only two subassemblies are depicted, however the disclosure contemplates multiple subassemblies supporting expanded lengths of conduit.

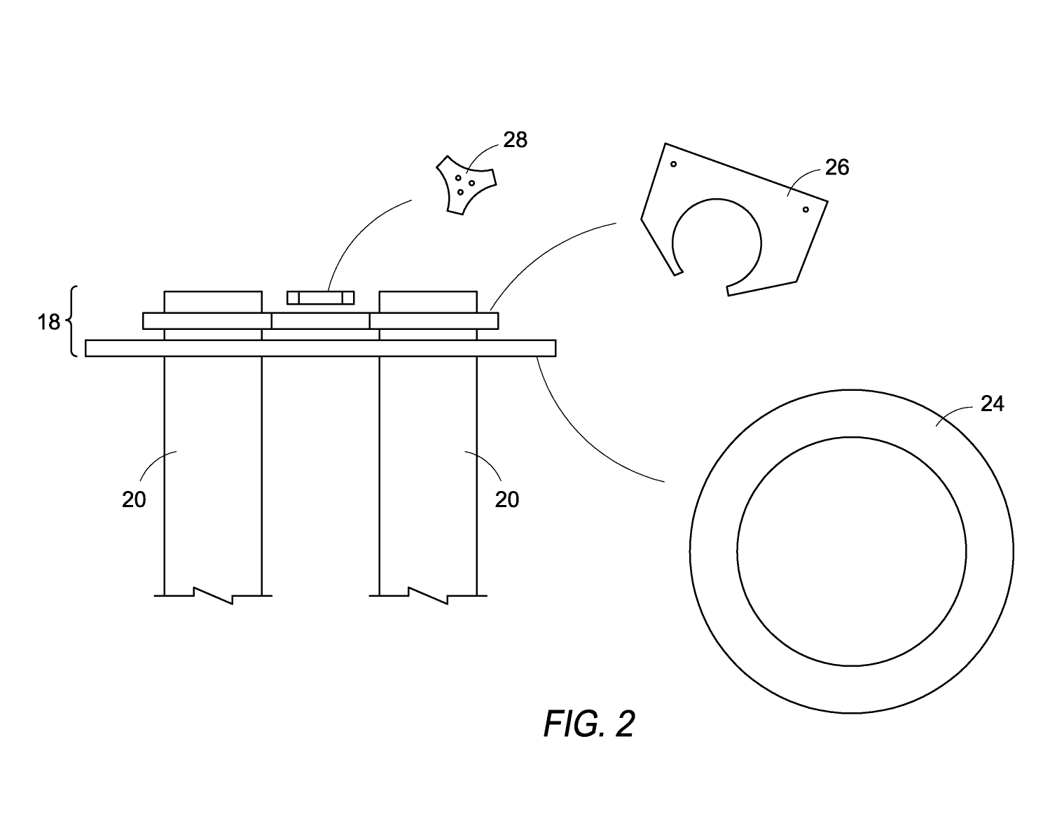

Referring next to FIG. 2, subassembly 18 is shown in a semi-exploded view about conduit 20. Each of the components of subassembly 18, components 24, 26, and 28, may be constructed of plate steel, for example, and that plate steel may be 1″ to 2″ thick, for example. Specific steel may be selected, and other components inert to specific needs of the conduit may also be selected, such as stainless steel, for example, and/or a noncorrosive aluminum, for example. Subassembly 18 can include components 24, 26, and 28.

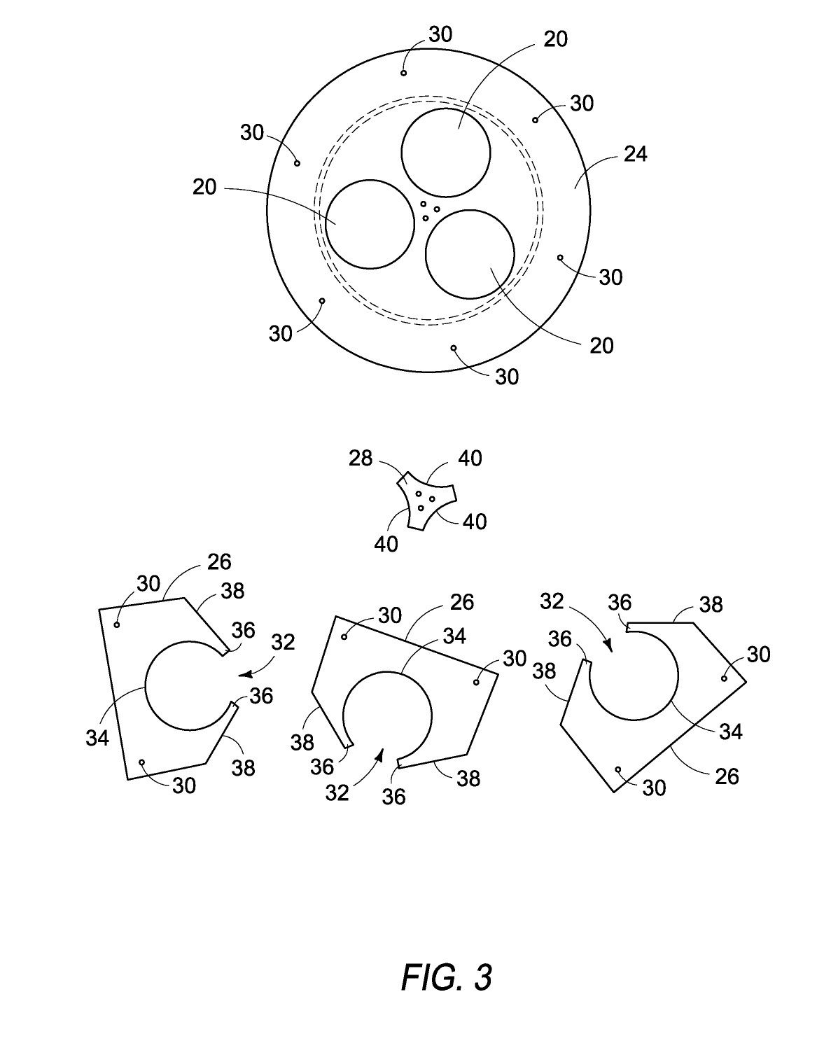

Referring next to FIG. 3, components 24, 26 and 28 are shown in more detail. Referring first to component 24, component 24 defines an annular ring or rim which may have openings therein. These openings may be configured to receive conduits 20 as shown and/or coupling assemblies such as screws or bolts within openings 30 as shown. Subassembly 18 can be utilized at the very top or beginning of a conduit string and is not meant to be utilized intermediate between endings of a conduit string. As such, subassembly 18 can be utilized to affix portions of conduit 20 in place and provide a stable base for the conduit to extend from.

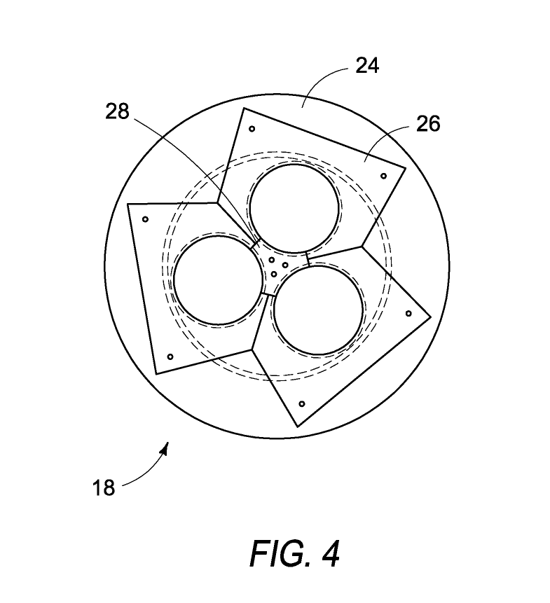

Components 26 of subassembly 18 can be individual bracket components that define both openings 30 configured to receive coupling assemblies as well as openings 32 configured to embrace conduit 20 within component 24. As can be seen, opening 32 can define a semicircle with an arcuate edge that completes upward to between 60% and 70% of a complete circle to embrace conduit 20. Edges 38 can extend to support the partial opening 34, and these edges 38 can extend to ends 36. Ends 36 are configured to embrace cap component 28, which includes complimentary recess edges 40 configured to complete the remaining circular opening 32 and embrace conduit 20. Component 28 can have three edges, each of them arcuate in nature, with blunt ends configured to embrace ends 36 of component 26. Referring next to FIG. 4, a top view of subassembly 18 is shown.

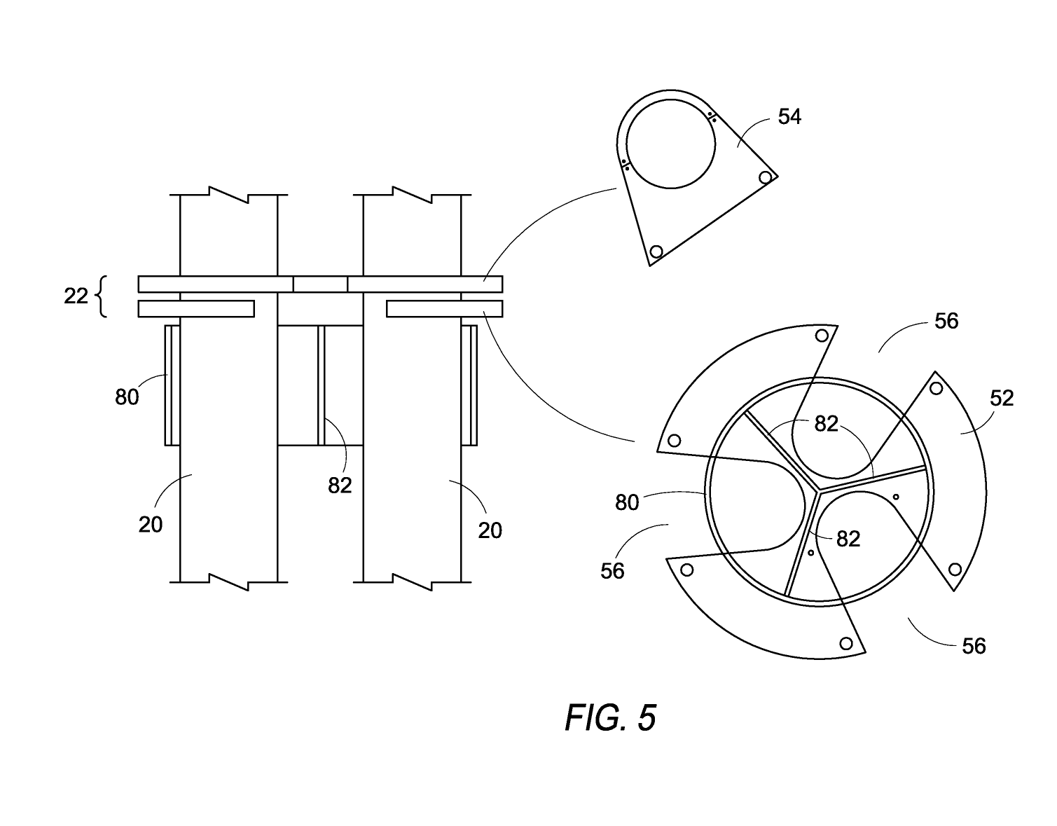

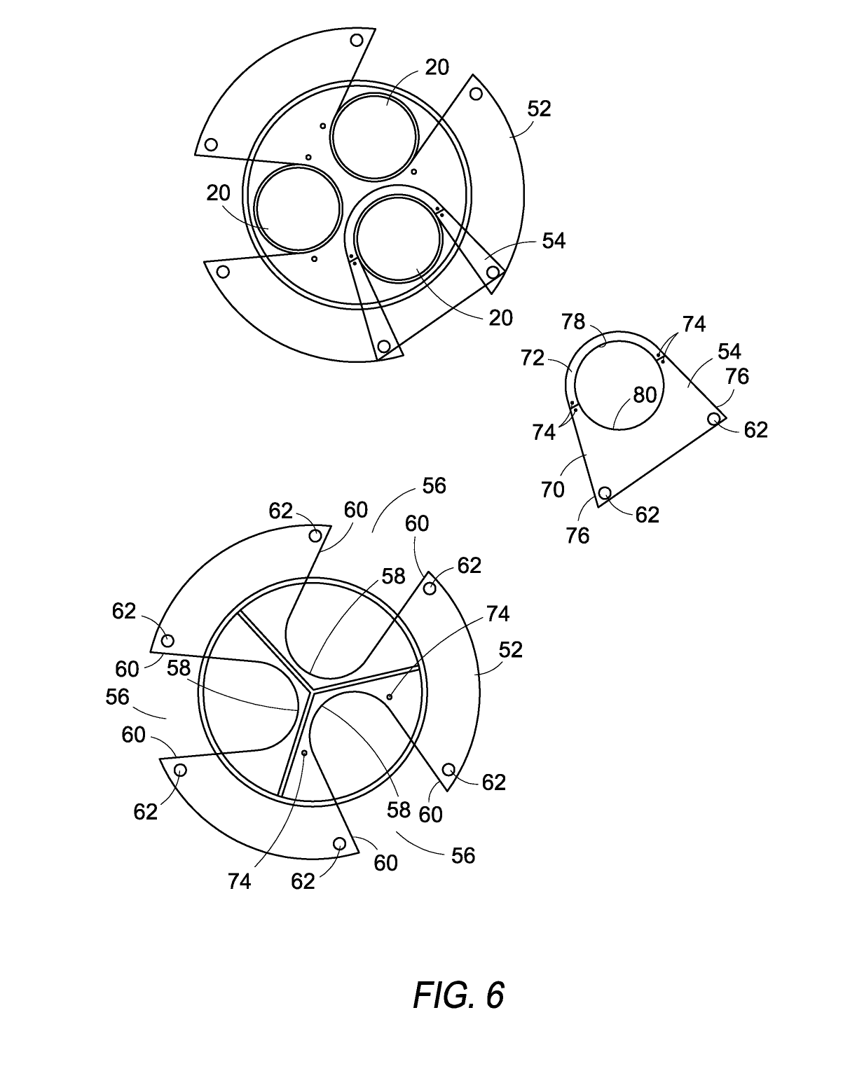

Referring next to FIGS. 5 and 6, subassembly 22 is shown. Subassembly 22 can be used alone or in combination with subassembly 18 and can allow for the decoupling of individual pipes along the string that is configured using subassembly 18 and subassembly 22, for example. Subassembly 18 may be employed at one or both terminus of the pipe string and subassembly 22 may be employed between one or both terminus of the pipe string. As can be seen, subassembly 22 can include at least two components, component 52 and component 54. Component 52 can be a hub component that extends centrally to at least three flanges that define openings 56 in between each of the three flanges. Opening 56 can be a semicircle wherein at least less than 50% of the semicircle is completed that allows for the removal through opening 56. As can be seen, each of opening 56 includes a semicircle portion 58 that resides towards the center of component 52. Along these openings, sidewalls 60 can advance from the semicircle opening at an outward angle expanding to define a terminus opening that is wider than the diameter of the defined semicircle opening 58. Component 52 can include opening 60 that can be configured to allow for the coupling of component 54 thereto.

Bracket component 54 can include at least two components. One component is an outward component that can be coupled to secure piping between its arcuate opening 80 and arcuate opening 58. Another component 78, such as a cap component, may be provided to further embrace conduit within the completed circular opening of component 54. As can be seen, component 54 can include sidewalls 76. These sidewalls 76 can extend at an angle to allow for the spacing of multiple components 54 about component 52. This angle can be other than normal and extend at an angle in relation to the front edge of component 52 that is less than 90°. As can be seen, components 54 and 52 can be utilized to embrace conduit 20.

Buttress assemblies such as assembly 80 can also be incorporated with the subassemblies. Assembly 80, for example, can define a ring that is supported by members 82. Pipes can be aligned within openings defined by the ring and members 82.

Upon the requirement for removal of one of the pipes from the assembly, one of components 54 can be removed, allowing for the removal of one of the pipes within the conduit without impacting the support of the remaining pipes or conduits that are bundled together.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A conduit support assembly comprising:
a rim configured to encompass a plurality of conduit;
a plurality of brackets above the rim and extending toward the center of the rim, each of the brackets having a curved opening configured to receive one of the plurality of conduit; and
a center cap configured to couple with the plurality of brackets.

2. The conduit support assembly of claim 1 wherein the conduit is pipe having a diameter of less than 12 inches.

3. The conduit support assembly of claim 1 wherein one cross section a depth of the rim is less than a height of the rim.

4. The conduit support assembly of claim 1 wherein each of the brackets defines an arcuate opening having sidewalls completing greater than 50% of a circle.

5. The conduit support assembly of claim 1 wherein the center cap defines arcuate edges, the arcuate edges of the center cap completing the curved opening of the brackets to form a complete circle when operatively engaged.

6. A conduit support assembly comprising:
a hub defining a plurality of recesses between extensions emanating from a center of the hub, each of the recesses defining an arcuate portion proximate the center of the hub and opposing linear portions extending toward an outward perimeter of the hub; and
a plurality of brackets above the hub and extending toward the center of the hub, each of the brackets having a curved opening wherein when coupled to the hub form a complete circular opening configured to embrace conduit.

7. The conduit support assembly of claim 6 wherein each of the recesses defines an opening along an outer edge of the hub, the opening being larger than a diameter of a circle completed using the arcuate portion.

8. The conduit support assembly of claim 6 wherein each of the brackets defines opposing lateral edges that extend at an angle less than 90 degrees from a base, the lateral edges having the curved opening there between.

9. The conduit support assembly of claim 6 further comprising a cap configured to couple with each bracket.

10. The conduit support assembly of claim 9 wherein the cap completes a circle from the curved opening.

11. A conduit and support assembly, the assembly comprising:
a first subassembly comprising:
a rim configured to encompass a plurality of conduit;
a plurality of brackets above the rim and extending toward the center of the rim, each of the brackets having a curved opening configured to receive one of the plurality of conduit; and
a center cap configured to couple with the plurality of brackets; a second subassembly comprising:
a hub defining a plurality of recesses between extensions emanating from a center of the hub, each of the openings defining an arcuate portion proximate the center of the hub and opposing linear portions extending toward an outward perimeter of the hub; and
a plurality of brackets above the hub and extending toward the center of the hub, each of the brackets having a curved opening wherein when coupled to the hub form a complete circular opening configured to embrace conduit; and
a plurality of conduit extending between the first and second subassemblies.

12. The assembly of claim 11 further comprising a plurality of second subassemblies engaging the lengths of conduit.

13. The assembly of claim 11 wherein the subassemblies are coupled to the ceiling of a subterranean room.

14. The assembly of claim 11 wherein the subassemblies are coupled to the wall of a subterranean shaft.

15. The assembly of claim 11 wherein the curved openings of the first subassembly linearly align with the curved openings of the second subassembly.

16. A method for removing conduit from a support assembly, the method comprising:
supporting a plurality of conduit about a central hub component with each of the plurality of conduit being coupled within the central hub component using a bracket; and
removing the bracket to release one conduit from the central hub.

17. The method of claim 16 further comprising maintaining the support of the other conduit while the one conduit is released.

18. The method of claim 16 further comprising supporting the end of the plurality of conduit with a rim.

19. The method of claim 18 further comprising supporting each of the plurality of conduit within the rim by coupling the conduit to a bracket coupled to the rim.
